(19) United States
(12) Patent Application Publication
(10) Pub. No.: US 2024/0155966 A1
(43) Pub. Date: May 16, 2024

(54) MODULAR CLOSING WHEEL

(71) Applicant: SCHAFFERT MANUFACTURING COMPANY, INC., Indianola, NE (US)

(72) Inventor: Paul E. SCHAFFERT, Indianola, NE (US)

(21) Appl. No.: 18/498,678

(22) Filed: Oct. 31, 2023

Related U.S. Application Data
(60) Provisional application No. 63/424,225, filed on Nov. 10, 2022.

(51) Int. Cl. A01C 5/06

(52) U.S. Cl. CPC A01C 5/068

(57) ABSTRACT

A closing wheel includes a hub and a rim configured to rotate about an axis and couple to a trailing arm assembly of a tractor. The closing wheel may act to close a seed furrow. The closing wheel may be a modular closing wheel where the hub is defined by portions and the rim is defined by modular pieces. The portions of the hub may define features to support or couple the rim to the hub. The modular pieces of the rim may each connect to an adjacent modular piece. The modular pieces may include radial features extending from the rim and configured to disturb soil.

### CROSS-REFERENCE TO RELATED APPLICATIONS

This application claims the benefit of priority pursuant to 35 U.S.C. 119(e) of U.S. Provisional Patent Application No. 63/424,225, filed Nov. 10, 2022, entitled “Modular Closing Wheel,” which his hereby incorporated by reference herein in its entirety.

### FIELD

This invention relates generally to closing wheels for seed furrow closing assemblies, methods of use, and methods of manufacturing thereof, and more specifically to modular closing wheel assemblies.

### BACKGROUND OF THE INVENTION

Agricultural seed planting is typically accomplished by multi-row planters. A planter may include multiple row units configured for opening a seed furrow, depositing seeds within the furrow, and closing the seed furrow around the seeds. In some cases, each row unit of the planter may also open a fertilizer furrow adjacent to each seed furrow, deposit liquid fertilizer in each fertilizer furrow, and close each fertilizer furrow. Further, a press wheel or firmer wheel may often be used for compacting the soil in the seeded furrows after the soil has been planted and after a closing wheel has deposited loose soil overtop of the seed.

Conventional closing wheels may be coupled to an agricultural unit for closing seed furrows and distributing the soil over and into the seeded furrows after the seed has been planted. The use of press wheels and closing wheels on planters to close furrows and compact soil around and over seeds deposited in the bottom of a seed furrow has been practiced for many years. The purpose of compacting the soil is to promote seed germination by minimizing air pockets, thus improving the capillary action of the moisture in the soil as well as reducing wind erosion of the soil over the seed.

Traditionally, closing wheels may include rubber tires mounted over a central hub having a fixed diameter that are pulled along a seed furrow to break down sides of a furrow to redistribute the soil over the seed. However, conventional closing wheels may smear the soil over the seed furrow area, rather than evenly distributing the soil. As a result, the furrow may not be completely closed and instead a hard sidewall to the furrow may be formed. Smearing may be particularly an issue when the soil is wet due to precipitation or when liquid fertilizers or other liquids are distributed with a seed into the furrow. Further, when wet planting conditions are followed by hot or windy days, the soil may crack and become like concrete over the seed trench area. These conditions may result in seeds being exposed in the furrow, seeds failing to germinate, roots failing to penetrate the hard sidewalls formed by the wheels, and plants falling over during growth due to weak root structures.

Some conventional closing wheels utilize metal features in place of rubberized tires, often with tines or other extensions along their perimeter. The metal features used for soil redistribution and furrow closing can take the form of repeating extensions, or “tines,” extending radially outward from the closing wheel. The shape, size, and curvature of the metal tines can require complicated machining and cutting paths, increasing manufacturing costs. These metal rings are often cut from metal sheets, leaving large wasted center portions of scrap metal. In addition, when a single metal feature breaks or is damaged, the whole wheel must be replaced. As a result, manufacturing and repairing closing wheels with metal tines may be costly and produce large amounts of waste compared to the amount of material used for the completed closing wheel.

Accordingly, conventional press and closing wheels and techniques may fail to adequately distribute soil and close seed furrows and may produce large amounts of waste during manufacturing. As such, there is a need for systems and techniques to replace conventional closing wheels with systems ensure proper seed furrow soil conditions while also limiting the amount of waste produced.

### BRIEF SUMMARY OF THE INVENTION

Examples of the present invention are directed to modular closing wheel assemblies and methods of use thereof.

In one example, a closing wheel may be coupled to a trailing arm assembly of an agricultural tractor. The closing wheel may include a hub including a base wall defining a recessed circumferential channel, the base wall may have a radius of curvature. The base wall may further include a rim configured to couple to the hub within the circumferential channel and around the base wall, the rim may include a plurality of modular pieces. Each of the plurality of modular pieces may include an inner edge defining a curved surface having the radius of curvature, an outer edge opposite the inner edge, the outer edge defining repeating radial extensions, a forward edge extending between the inner edge and the outer edge, and a rearward edge. The rearward edge may be opposite the inner edge and configured to abut a forward edge of an adjacent modular piece.

In another example, the hub may include a first portion and a second portion configured to couple to the first portion. When coupled, the first portion and second portion may define the recessed circumferential channel and the base wall.

In another example, the closing wheel may further include an insert. The insert may be configured to align annularly between the inner edge of the rim and the base wall of the hub when the rim is coupled to the base wall. The insert may be configured to limit the movement of the rim relative to the hub.

In a further example, the insert may be a rubber belt.

In another example, the closing wheel may further include a first retaining feature, which may be defined by the hub, and a second retaining feature that may be defined by the rim and configured to engage the first retaining feature to limit a movement of the rim relative to the hub.

In another example, the closing wheel may further be configured such that the forward edge may define a first modular coupling feature and the rearward edge may define a second modular coupling feature configured to engage the first modular coupling feature of an adjacent piece of the plurality of modular pieces to couple the adjacent pieces together.

In a further example, the first modular coupling feature may define an extension from the forward edge and the second modular coupling feature may define a recess in the rearward edge.

In another example of the closing wheel, the repeating radial extensions may be configured to disturb soil to close a seed furrow.

In a second example, a seed furrow closing wheel may include a hub, the hub may include a first portion, a second portion that may be coupleable to the first portion to define a base wall and two opposing sidewalls, the base wall and sidewalls may define a recessed circumferential channel with a radius of curvature, and an aperture which may extend through a center of the first and second portions and may be configured to receive an extension of an agricultural trailing arm assembly. The seed furrow closing wheel may further include a modular rim, the modular rim may include a plurality radially aligned modular pieces, the modular rim may define repeating radial extensions extending from an outer edge of the modular rim, and an inner edge which may be opposite the outer edge, the inner edge may have the radius of curvature. Further, the opposing sidewalls of the hub may limit movement of the modular rim relative to the hub.

In another example, the seed furrow closing wheel may further include a first retaining feature that may be defined by the base wall and a second retaining feature that may be defined by at least one modular piece and may be configured to align with the first retaining feature. The first and second retaining features may limit the movement of the rim relative to the hub.

In another example, the modular pieces of the seed furrow closing wheel may include a forward edge which may define a first modular coupling feature and a rearward edge opposite the forward edge which may define a second modular coupling feature configured to align with the first modular coupling feature of an adjacent modular piece of the plurality of modular pieces.

In a further example of the seed furrow closing wheel, the first modular coupling feature and the second modular coupling feature may define welds.

In a further example of the seed furrow closing wheel, the first modular coupling feature may define an extension from the forward edge of a first modular piece and the second modular coupling feature may define a recess in the rearward edge of a second modular piece, wherein the extension may be received by the recess to couple the first and second modular pieces.

In another example of the seed furrow closing wheel, the radial extensions may be configured to disturb soil to close a seed furrow when the wheel is coupled to the agricultural trailing arm assembly.

In a third example of the seed furrow closing wheel, the seed furrow closing wheel may be configured to couple to a trailing arm of an agricultural tractor. The seed furrow closing wheel may include a modular rim. The modular rim may include a plurality of modular pieces and may have an inner circumferential edge that may define a radius of curvature and an aperture. Each modular piece of the plurality of modular pieces may include an outer edge which may define repeating radial extensions extending outwardly and configured to disturb soil, a first side that may define a first modular coupling feature, a second side opposite the first side, the second side may define a second modular coupling feature, and wherein the second modular coupling feature may be configured to couple with the first modular coupling feature of an adjacent modular piece of the plurality of modular pieces. The seed furrow closing wheel may further include a rim support structure coupled to an extension of the trailing arm and may define a base wall having the radius of curvature and may be configured to support the modular rim.

In another example of the seed furrow closing wheel, the rim support structure may include a first portion that may define a first section of the base wall and a second portion that may define a second section of the base wall. The second portion may be configured to couple to the first portion.

In another example, the seed furrow closing wheel may further include an insert that may be configured to align annularly between the inner circumferential edge and the base wall, wherein the insert may limit a movement of the modular rim relative to the rim support structure.

In another example, the seed furrow closing wheel may further include a first retaining feature that may be defined by the rim support structure and a second retaining feature that may be defined by the modular rim and configured to align with the first retaining feature. The first and second retaining features may be coupled to limit a movement of the modular rim relative to the rim support structure.

In another example of the seed furrow closing wheel, the first modular coupling feature may defines an extension, the second modular coupling feature may define a gap, and adjacent modular pieces of the plurality of modular pieces may couple when the extension of a first modular piece of the adjacent modular pieces is placed in the gap of a second modular piece of the adjacent modular pieces.

In a fourth example, a wheel coupled to a planter assembly towed by an agricultural tractor may be disclosed. The wheel may include a hub having a peripheral edge portion, a rim including a plurality of modular pieces, each of the plurality of modular pieces may include an inner edge, an outer edge opposite the inner edge, the outer edge defining at least one radial extension, a forward edge extending between the inner edge and the outer edge, and a rearward edge, the rearward edge opposite the inner edge and configured to abut a forward edge of an adjacent modular piece. The plurality of modular pieces may be positioned around and attached to the peripheral edge portion.

In an additional example of the wheel, the plurality of modular pieces may attach to the peripheral edge portion and may be fixed relative to the hub.

In another example of the wheel, the plurality of modular pieces may each engage with two adjacent modular pieces.

In at least one example of the present disclosure, a method of manufacturing a modular rim of an agricultural wheel method may include providing a sheet of material defining a cutting area and cutting a set of modular pieces from the sheet of material within the cutting area, the set of modular pieces configured to be assembled together to form the modular rim. In such an example, the cutting area may be less than an area defined by an outer diameter of the modular rim when assembled. In such an example, each modular piece of the set of modular pieces may include an inner edge defining a curved surface, an outer edge opposite the inner edge, the outer edge defining repeating radial extensions, a forward edge extending between the inner edge and the outer edge, and a rearward edge, the rearward edge opposite the inner edge and configured to abut a forward edge of an adjacent modular piece.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a side view of an agricultural tractor and an agricultural planter;

FIG. 2 depicts a top-rear perspective view of the agricultural tractor and agricultural planter of FIG. 1, with a closing wheel;

FIG. 3 depicts a top-rear perspective view of a tail section of the agricultural planter and the closing wheel of FIG. 2;

FIG. 4A depicts a rear elevation view of a pair of example closing wheels and a seed in an open seed furrow;

FIG. 4B depicts a rear elevation view of the closing wheels of FIG. 4A and a seed in a closed seed furrow;

FIG. 5 depicts a perspective view of an example closing wheel;

FIG. 6A depicts an exploded view of the closing wheel of FIG. 5;

FIG. 6B depicts a perspective view an inner face of a first portion of the hub of the closing wheel of FIG. 6A;

FIG. 6C depict a perspective view of an outer face of the first portion of the hub in FIG. 6B;

FIG. 6D depicts a perspective view of an inner face of a second portion of the hub of the closing wheel and a modular piece of the rim of FIG. 6A;

FIG. 6E depicts a perspective view of outer face of the second portion of the hub of FIG. 6D;

FIG. 7 depicts a cross-sectional view of an example closing wheel;

FIG. 8 depicts a cross-sectional view of an example closing wheel with an insert;

FIG. 9A depicts a perspective view of a rim and modular pieces of an example closing wheel;

FIG. 9B depicts an exploded view of the rim of FIG. 9A;

FIG. 9C depicts an elevation view of the rim of FIG. 9A;

FIG. 10 depicts an elevation view of another example of a rim and a portion of a hub of a closing wheel;

FIG. 11A depicts a plan view of an example metal sheet including a template for an example of the modular pieces of a rim; and

FIG. 11B depicts a perspective view of the example modular pieces of FIG. 11A prepared for shipping.

### DETAILED DESCRIPTION OF THE INVENTION

The description that follows includes sample systems, methods, and apparatuses that embody various elements of the present disclosure. However, it should be understood that the described disclosure may be practiced in a variety of forms in addition to those described herein.

The following disclosure relates generally to modular closing wheels and associated systems and methods of use thereof. Closing wheels are generally a part of a trailing arm assembly coupled to a hitch of an agricultural planter and pulled over soil to be planted with seeds. Broadly, a closing wheel may be substantially any type of wheel or soil distributing device for closing seeded furrows by distributing soil over the planted furrow. For example, a closing wheel may be configured to distribute soil over the furrow in order to promote seed germination by compacting soil and minimizing air pockets. This can improve the capillary action of the moisture in the soil as well as reducing wind erosion of the soil over the seed. Closing wheels can also be configured modularly to facilitate less material waste during manufacturing, more compact and less expensive shipping, and cheaper, simpler repairs.

To facilitate the foregoing, closing wheels of the present disclosure may include a rim defined by a plurality of modular pieces having radial extensions configured to be modularly assembled and disassembled to form a single closing wheel. In addition, the wheels disclosed herein may generally include a hub that is configured to rotate about an axis.

In one example, the hub may be formed from two separate portions coupled along corresponding faces aligned with a plane perpendicular to the axial direction of the hub. The hub may define a rim supporting feature, such as a recessed channel, extending around an exterior perimeter of the hub. The rim supporting feature may receive the rim. In one example, the rim may have an inner diameter that matches an outer diameter of the rim supporting feature.

In another example a rubber insert, such as a belt, may be placed within the recessed channel, between the hub and the rim. The rubber insert material may have a relatively high coefficient of friction that may limit the movement of the rim relative to the hub and prevent slippage of the rim during use. The recessed channel may further define a bottom wall and corresponding, or opposing, upright walls. The channel may be of a sufficient depth such that when a rim is placed in the channel the upright walls cover a portion of the height of the rim. By covering the sides of the rim, existing plant material, such as cover crops, may be less likely to tangle and bind the closing wheel.

The rim may define a plurality of repeating features extending radially from an outer edge portion of the rim. In one example, the repeating features may be spikes extending outwardly from the rim and may be angled to extend in a direction opposite the direction of the rotation of the closing wheel during use. The spikes may assist in breaking down compacted seed furrow sidewalls, clumps of soil, and distributing the soil over a planted seed in a furrow. The closing wheel itself may be coupled to a trailing arm assembly of an agricultural planter at an angle, which may allow the spikes to direct soil towards a location of a seed in a furrow.

The rim may be formed from a plurality of modular pieces and the modular pieces may align or connect to form the rim around the perimeter of the hub. In one example, the modular pieces may have a substantially circular extension on one end and a substantially circular recess on an opposite end. The recess of an adjacent modular piece may receive the extension of one modular piece. Each modular piece may then connect to another modular piece forming a single annular rim. The modular pieces may be connected together on the hub or they may be assembled before the rim is placed on the hub. The plurality of modular pieces may allow for the rim, or parts of the rim, to be easily replaced during planting and to couple to hubs that may be originally configured to receive a rubber tire of a conventional closing or press wheel.

Each of the modular pieces may be cut from a sheet of metal through methods such a laser cutting. The modular pieces may then be stacked and tightly packed into boxes for shipments. Because the modular pieces may each have the same profile and lack an interior area to be removed during cutting as waste, larger quantities of modular piece style rims may be produced from a comparable size of metal sheet than conventional rings and may considerably reduce waste. Further, the modular rims may be shipped in smaller packages than a comparable conventional ring, or in greater quantities of the same size of packaging. As a result, the modular rim of the present disclosure may reduce shipping costs, manufacturing costs, and the total cost to a consumer.

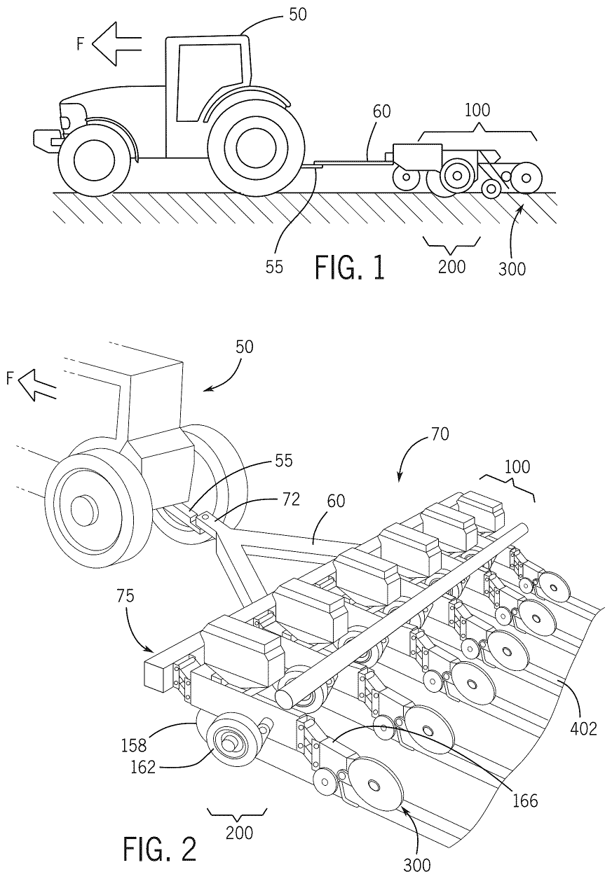

Turning to the Drawings, the modular press wheel of the present disclosure may be used with an agriculture planter 70 having one or more trailing arm assemblies 100, as shown in FIG. 1. Each trailing arm assembly 100 may include a fertilizer furrow opener assembly 150. The fertilizer furrow opener assembly 150 may be configured to open the soil, such as with an opener disc, and optionally supply fertilizer and/or a seed 20 to an open furrow 401. Each trailing arm assembly 100 may also include a trailing furrow closer assembly 200. The trailing furrow closer assembly 200 may be configured to close the open seed furrow 401 creating a closed seed furrow 402, such as with the closing wheel of the present invention. As described and shown herein, one or more closing wheels, such as the modular closing wheels 300 of the present disclosure may be connected to the trailing arm assemblies 100. One or more press wheels may be connected to an end of the trailing arm assemblies 110. This may allow the press wheel to firm the closed seed furrow 402 after closing.

The modular closing wheels 300 of the present disclosure may be used with a variety of different planters and trailing arm assemblies. For purposes of illustration, FIGS. 1 and 2 show the planter 70 as including a tongue 72 or hitch 55 for hitching the planter 70 to a hitch 55 of a tractor 50. The tractor 50 tows the planter 70 in the direction of arrow F and provides power to the planter 70 (e.g., via a power take off (“PTO”)) for powering the operations of the planter 70. As illustrated in FIG. 2, the planter 70 may include a frame 75 from which the hitch 55 extends and the various planter components are supported. The various components of the planter 70 may include the plurality of trailing arm assemblies 100. The trailing arm assemblies 100 may function as row units for planting seeds and distributing liquid fertilizer, for example, from a common liquid fertilizer tube 170.

While many configurations are possible, each row unit shown in FIG. 2 may include a frame 154 for supporting various components of the planter 70. The row units in FIG. 2 are shown as including a furrow opener disc 158, a gage wheel 162, and a furrow closer frame 166. Broadly, the seed furrow opener disc 158 may be configured to create a furrow in which the planter 70 deposits seed. In creating the seed furrow, the furrow opener disc may form a seed furrow sidewall, which may include harder or more compacted soil. The gage wheel 162 may be configured to determine or control a depth at which the planter 70 deposits the seed. The planter 70 may further include a series of the trailing arm assemblies 200, each of which may include a modular closing wheel 300 followed by a press wheel and associated subassemblies. This configuration allows for treating the soil after the furrow has been closed by the modular closing wheel 208.

Any of the features, components, and/or parts, including the arrangements and configurations thereof shown in FIGS. 1 and 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1 and 2.

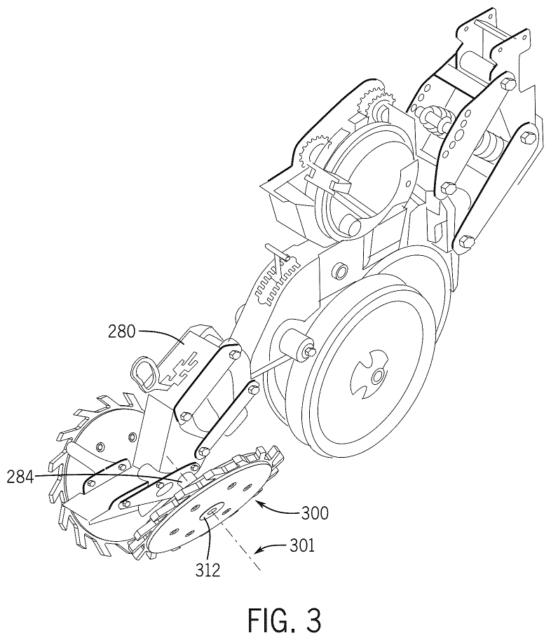

As shown in FIG. 3, modular closing wheels 300 may couple to either side of the mounting fork 280 at predetermined angle. The predetermined angle may define a closing angle 355. The predetermined angle may align the modular closing wheels along an open seed furrow 401. In other examples, only one modular closing wheel 300 may be used. In some cases, the modular closing wheels 300 may be positioned on the sides of so as to distribute soil to the center of the open seed furrow 401 and may further break down sidewalls of the furrow, thus forming a closed seed furrow 402. Additionally or alternatively, the modular closing wheels 300 may be positioned in a spaced relationship outside of the open seed furrow 401 to move additional soil into the open seed furrow 401. In some examples, modular closing wheels 300 may be staggered such that one modular closing wheel 300 is located in a direction closer to the tractor while another closing wheel may be located further from the tractor. The position of the modular closing wheel 300 may be independent of the location of the opener disc 158 or other features of the trailing arm assembly 100. For example, in some uses the modular closing wheel 300 may be placed in front of, or closer, to the opener disc 158. In such an example, the modular closing wheel 300 may act to disturb dirt but not to close a seed furrow. In further examples, the modular closing wheel 300 may be behind a separate closing wheel and may act to compact soil on a seed furrow or move additional soil to or from the seed furrow.

The modular closing wheel 300 may be configured to rotate about a central axis 301 that may be defined by an axle 284, bearing 312, or similar feature that is rotatably coupled to the mounting assembly, such as the fork 280, or similar feature on a trailing arm assembly. The modular closing wheel 300 is generally configured to rotate about the central axis 301 when the tractor 50 is in motion. As the modular closing wheel 300 rotates, it may break up or move soil. For example, the modular closing wheel 300 may apply a downward pressure, a cutting action, or apply a force sufficient to move, break up, or compact soil of, around, or into an open seed furrow 401 and form a closed seed furrow 402. The force may originate with the trailing arm assembly 100 or may be the result of the positioning of the one or more of the modular closing wheels 300.

Any of the features, components, and/or parts, including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

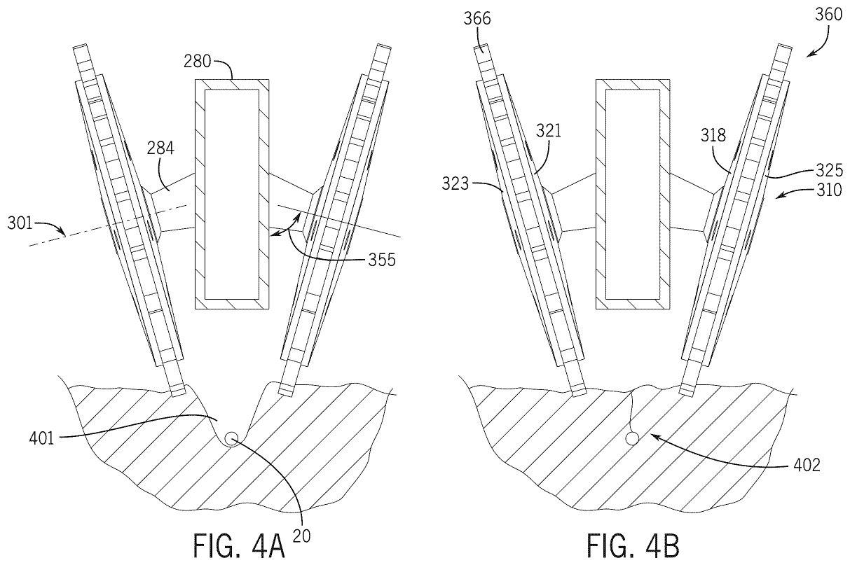

With reference to FIGS. 4A and 4B, an example of a pair of modular closing wheels 300 is shown. FIG. 4A shows the example modular closing wheels 300 around an open seed furrow 401, while FIG. 4B shows the modular closing wheels 300 after closing the seed furrow 402. The modular closing wheels 300 may be positioned at a closing angle 355 sufficient to break up and direct soil to a desired location, such as into the open seed furrow of FIG. 4A to close the seed furrow. This operation may form a closed furrow 402, as shown in FIG. 4B. The pressure against the soil may come from a modular rim 360 or other radial features 366 of the modular closing wheel 300. A sufficient amount of soil may be distributed into the open seed furrow 401 to cover a seed 20. The modular closing wheel may also create a relatively even top surface of soil. The modular closing wheel 300 may be positioned such that radial features 366, such as spikes, teeth, or tines, of the modular closing wheels 300 may contact the soil at locations over a certain portion of the modular rim 360, and then may exit the soil near another portion of the modular rim 360. In one example, the modular rim 360 may engage the soil between approximately the four and seven o'clock positions relative to the modular closing wheel 300 and then may release from the soil at approximately the eight o'clock positions. The radial features 366 may be angled such that when the closing wheel rotates through the soil the radial features 366 release approximately perpendicular from the ground such that the soil remains compacted. In other examples, the soil may be of such a consistency that more aggressive radial features 366 that continue to move soil as they exit the ground may be require to break down and distribute additional soil.

Any of the features, components, and/or parts, including the arrangements and configurations thereof shown in FIGS. 4A and 4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A and 4B.

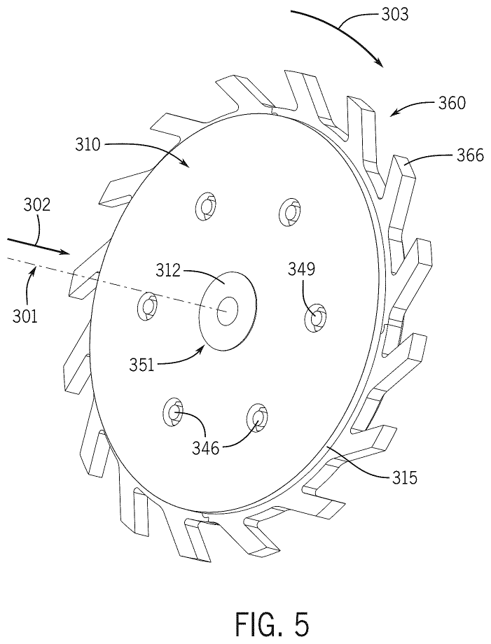

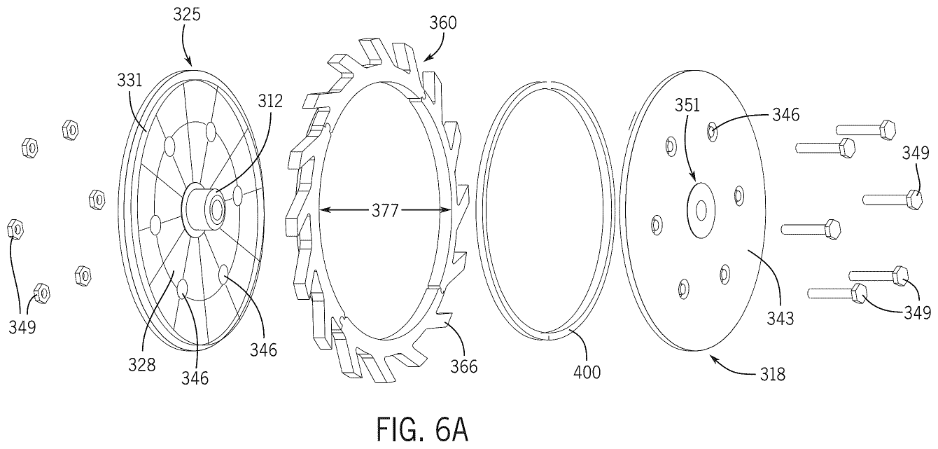

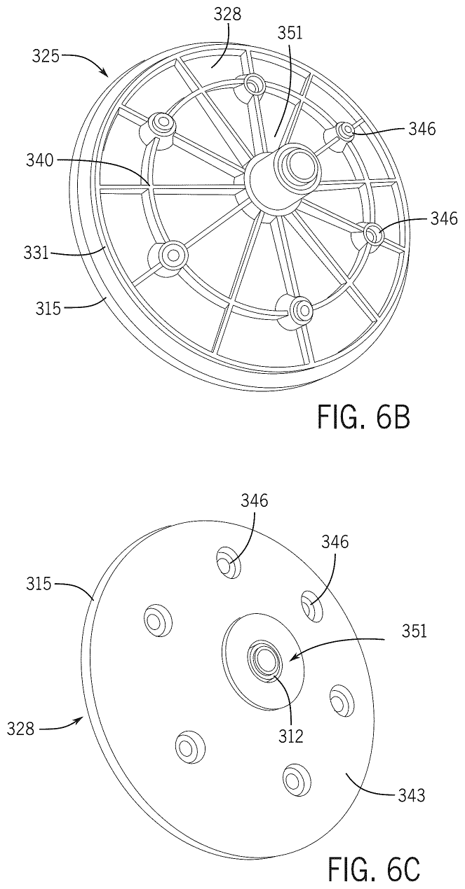

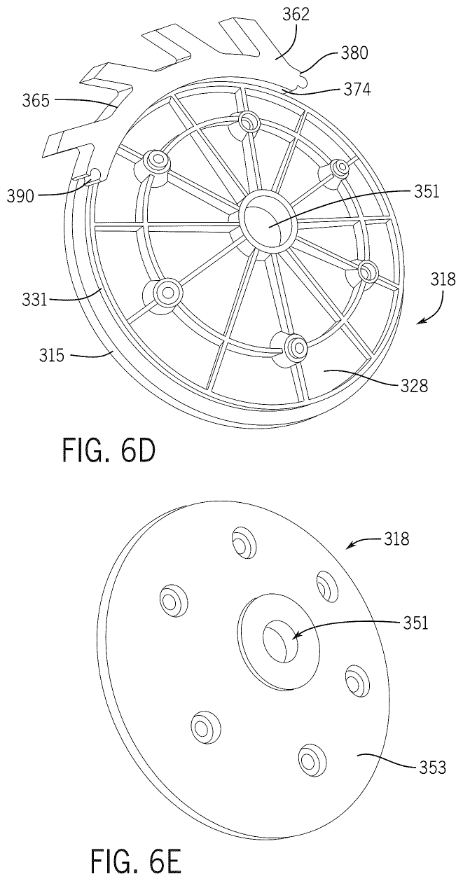

With reference to FIG. 5 through 6D, an example of a hub 310 of a modular closing wheel 300 of the present disclosure is shown. The modular closing wheel 300 may include a hub 310 and a rim, such as a modular rim 360, and may rotatably couple to a feature of a trailing arm assembly 100 such as a mounting fork 280. A bearing 312 or similar feature may also be included to facilitate rotation of the modular closing wheel 300. An insert 400 may also be included to aid in securing the modular rim 360 to the hub 310 and limiting rotation of the modular rim 360 relative to the hub 310 during use. The hub 310 may be a component uniquely designed for receiving a modular rim 360. Alternatively, the hub 310 may be a conventional hub configured to utilize a runner tire and the modular rim 360 of the present disclosure may be configured to be placed on such a hub 310. In examples where the hub 310 may be a conventional hub, the cost to a user may be reduced by requiring only the modular rim 360 of the present disclosure rather than an entire modular closing wheel 300.

The hub 310 may be a circular central portion of the modular closing wheel 300. The hub 310 may have a circular perimeter when viewed from a direction parallel to the central axis of rotation 301, defining the axial direction 302. When viewed from the front or rear, defined as a direction perpendicular to the axis 301 of rotation, the hub 310 may have rectangular, trapezoidal, elongated oval, or other shape. The hub 310 may be a single object. Alternatively, the hub 310 may be formed from a plurality of separate portions, such as two portions as shown in FIG. 6A. When the hub 310 is formed from two or more portions, there may be a first portion 318 and a second portion 325.

As shown in FIGS. 6C and 6E the portions of the hub 310 may define faces having relatively uniform profiles as viewed from the front, or the rear. The first portion 318 and second portion 325 may have interior faces 328 and exterior faces 343, where the interior faces 328 of the portions are configured to align with the interior face 328 of the other portion. The exterior faces 343 of the portions may define the faces opposite the interior faces 328. One of the first portion 318 or second portion 325 of the hub 310 may be configured for placement on a side closer to the trailing arm assembly, defining an inside portion 321. Another portion may be configured for placement on a side further from the trailing arm assembly 100, defining an outside portion 323. The hub 310 may have a circular perimeter portion 315, defined as the outer edge regions of the portions of the hub 310 when viewed from the axial direction 302.

In operation, portions of the hub 310 having relatively uniform shapes, as viewed from the front or the rear, may limit the amount of plant material or debris that attaches to, snags, or builds up on the modular closing wheel 300 during use. The shapes may assist in deflecting plant material, mud, and other debris away from, or off, the modular closing wheel 300. By reducing the amount of plant material and debris that adheres to the modular closing wheel 300, the modular closing wheel 300 of the present disclosure may more evenly distribute soil and may require less frequent maintenance and inspection when compared to conventional closing wheels, such as designs made from a single piece.

Portions of the hub 310, such as the first portion 318 and second portion 325, may define corresponding hub coupling apertures 346. The hub coupling apertures 346 may be smooth or countersunk to receive a feature of a fastener 349. The hub coupling apertures 346 may be threaded to receive a threaded fastener. Hub coupling apertures 346 on the first portion 318 may align with the hub coupling apertures 346 of the second portion 325. The hub coupling apertures 346 may be arranged in a variety of patterns. In one example, the hub coupling apertures 346 may be aligned annularly around a central aperture 351 of the hub 310. Fasteners 349 may be received through the hub coupling apertures 346 and may secure the first portion 318 and second portion 325 of the hub 310 together. The fasteners 349 may include a plurality of bolts and nuts, as shown in FIG. 6A, pins, screws, or similar structures.

The hub 310 may also define a central aperture 351 defining an aperture about the axis 301 of rotation and extending through the hub 310. The central aperture 351 may be configured to receive a feature of the trailing arm assembly 100 or to receive a bearing 312. The central aperture 351 may be configured to retain or to receive such a feature in the hub 310.

Any of the features, components, and/or parts, including the arrangements and configurations thereof shown in FIGS. 5-6E can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A-6E.

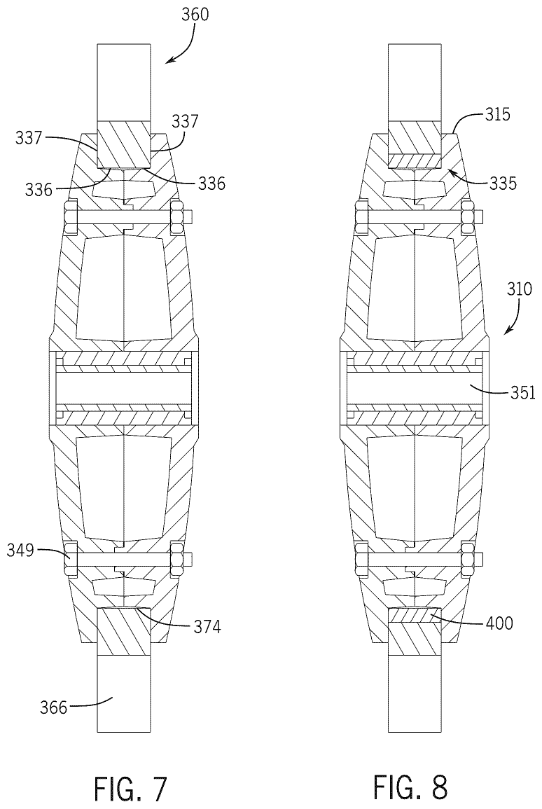

In examples where the hub 310 includes a first portion 318 and a second portion 325, the portions may have an exterior face 343 and an interior face 328. The interior faces 328 of the portions may define rim support features 331 or structures extending from the faces in the axial direction 302 annularly around the perimeter of each portion, as shown in FIGS. 6B and 6D. The rim support features 331 may support a rim, such as the modular rim 360. The rim support features 331 may define a radius of curvature about the hub 310. The rim support features 331 of the first portion 318 and second portion 325 may align when the portions of the hub 310 are coupled, as shown in FIG. 7. For example, when the portions of the hub 310 are attached the rim support features 331 may define a single recessed circumferential channel 335 extending around the hub 310 near the perimeter portion 315 of the hub 310. As shown in FIG. 7, the rim support features 331 together may define a bottom wall 336 extending annularly around the axis 301 of rotation and spaced annularly from the perimeter portion 315 of the hub 310. The interior faces 328 of the two portions may define corresponding, or opposing, upright walls 337 that extend up to the perimeter of the hub 310 from the bottom wall 336. The upright walls 337 may be parallel, offset at an angle relative to each other, or curved. Similarly, the bottom wall 336 may have a curved, angled, or generally flat profile and the width of the bottom wall 336 may be the same as or similar to a width of the modular rim 360 of the present disclosure. The configuration of the rim support features may allow the hub 310 to retain, support, or couple with the modular rim 360.

In other examples, only one of the first portion 318 or second portion 325 of the hub 310 may define a rim support feature 331. In other examples, one portion may define an extension as a rim support feature 331 and an additional portion may define a recess 393 configured to receive the extension as a rim support feature 331. In additional examples, the hub 310 may be a single structure with the rim support features 331 defined as a recess of the hub 310 or as some feature on the exterior of the hub 310. The rim support features 331 may be the same as, or defined by, the perimeter portion 315. The perimeter portion 315 and the rim support features 331 may be peripheral edge portions of the hub 310 located at or spaced relative to the circumference of the hub. The peripheral edge portion may be the location where the modular rim 360 attaches to the hub 310. In such an example, the modular rim 360 may attach to the peripheral edge portion of the hub 310 and be fixed relative to the hub 310.

The hub 310 of the present disclosure may be a single uniform material, or may include a variety of materials forming the hub 310 or portions of the hub 310. The hub 310 material may be a metal or a plastic sufficient to withstand repeated use in a variety of soil or weather conditions. As shown in FIGS. 6B and 6D, in examples where the hub 310 material may be a plastic, the interior faces 328 of the first portion 318 and second portion 325 may define a plurality of structural features 340 to increase durability or to disperse forces across the portions of the hub 310.

With respect to FIGS. 6A, 6D, and 7-9C, an example of a modular rim 360 may be disclosed. The modular rim 360 may generally couple to the hub 310 and break up or distribute soil into an open seed furrow 401 during use. In particular, the modular rim 360 may be configured to break down and eliminate sidewalls formed by a furrow opener of the trailing arm assembly. The modular rim 360 may be defined by a plurality of modular pieces 362 configured to radially align about the hub 310 of the closing wheel. The modular rim 360 may be defined by any number of modular pieces 362 sufficient to form an annular structure about the hub 310, forming the modular closing wheel 300. For example, the modular rim 360 may include two, three, four, five, or more modular pieces 362 assembled to form an annular structure. When the modular pieces 362 are aligned annularly, the modular rim 360 may be configured to be received by the rim support features 331 of the hub 310, such as within a recessed circumferential channel 335 as shown in FIGS. 7 and 8.

In some examples, the modular pieces 362 may each have an outer edge portion 365, an inner edge portion, a forward edge portion 380, and a rear edge portion 390. The outer edge portion 365 may be defined as a side of the modular pieces 362 configured to extend radially outward from the closing wheel. Each of the modular pieces 362 may together define an outer diameter 370 of the modular rim 360. The inner edge portion 374 may be a side opposite the outer edge portion 365. The inner edge portion 374 may be received by the rim support features 331 of the hub 310. The inner edge portions 374 of each of the modular pieces 362 may together define an inner diameter 377 of the rim 360. The forward edge portion 380 may be defined as a side of the modular pieces 362 extending between the outer edge portion 365 and the inner edge portion 374. The forward edge portion 380 may further be a side of a modular piece 362 configured to be oriented in the rotational direction 303 of the modular closing wheel 300. The rear edge portion 390 may be defined as a side opposite the forward edge portion 380. The forward edge portion 380 of a first modular piece 362 may be configured to align with the rear edge portion 390 of a second modular piece 362 such that each forward edge portion 380 of each modular piece 362 is aligned with a rear edge portion 390 of a next, or adjacent, modular piece 362.

Each or some of the outer edge portions 365 of the modular pieces 362 may define radial features 366 extending from an outer edge portion 365 of the modular pieces 362. The radial features 366 may be repeating. Each radial feature may be equally spaced from the next radial feature and have a similar shape. In other examples, the radial features 366 may differ in shape or may differ in spacing. The radial features 366 may be sufficient to break down, distribute, or otherwise move dirt into or onto an open seed furrow 401 by exerting a force on the soil. Depending on the soil conditions, it may be beneficial for a modular closing wheel 300 to utilize radial features 366 that prioritize evenly distributing soil into an open seed furrow 401 over maximizing the total volume of soil moved. In other examples, it may be beneficial to utilize more aggressive radial features 366 that move larger volumes of soil, or better break down soil or seed furrow sidewalls. Because the modular pieces 362 may be readily replaced, modular pieces 362 may be selected for use based off the radial features 366 defined by the outer edge portions 365. By utilizing a variety of radial features 366, the modular closing wheel 300 of the present disclosure may be optimized to reduce smearing of wet soil or optimized to break down more compacted seed furrow sidewalls.

Any of the features, components, and/or parts, including the arrangements and configurations thereof shown in FIGS. 7 and 8 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 7 and 8.

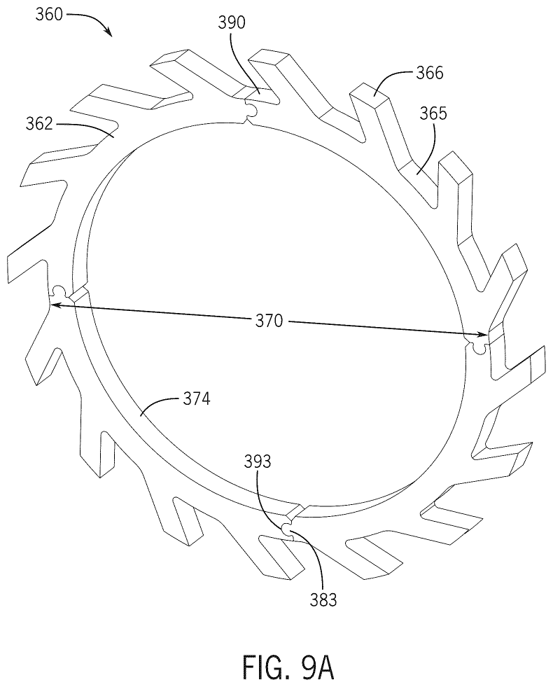

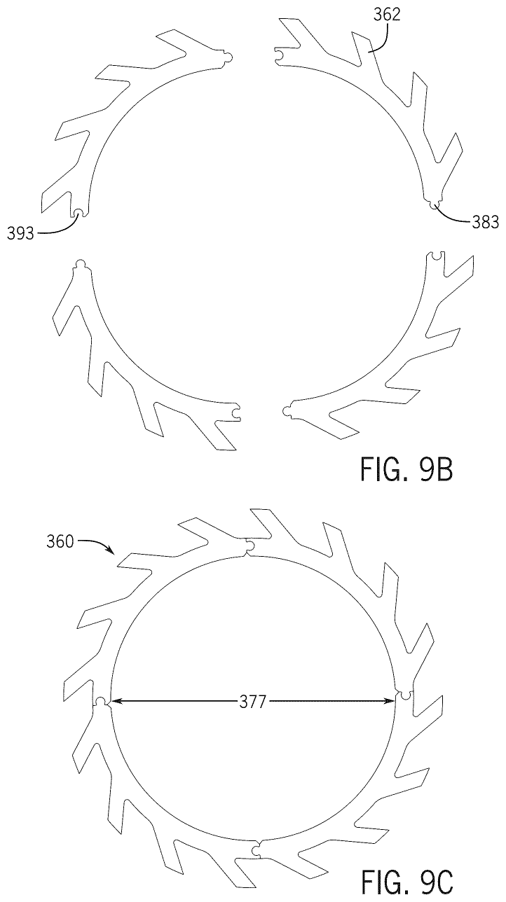

As shown in FIG. 9A-9C, the radial features 366 may extend from the outer edge portion 365 at an angle in a direction substantially opposite from the rotational direction 303 when viewed from a perspective parallel to the axial direction 302. The radial features 366 may be spikes. The angle of the spikes may allow for the spikes to engage soil of, or near, a seed furrow over a defined range relative to the axis 301 of rotation, such as between the four and seven o'clock positions. The range may be adjusted so as to move more or less soil for a variety of planting conditions. When engaging the soil, the configuration of the radial features 366 may promote the breakdown of soil, seed furrow sidewalls and the movement of soil generally. When the radial features 366 release from the soil they may exit at an angle or position sufficient for the radial features 366 to leave the soil at a near perpendicular position to the soil. In one example, spikes may leave the soil approximate the 8 o'clock position. The radial features 366 may be angled to reduce the amount the soil may be disturbed as the radial features 366 exit. As a result, the soil may remain relatively compacted over a seed 20 in the closed seed furrow 402. Soil compaction in the closed seed furrow 402 may reduce air pockets, promote the capillary action of water through soil, protect planted seeds from wind and weather, and generally promote seed 20 germination and plant growth.

In additional examples, the radial features 366 may also be tines, teeth, an edge, or similar features and may extend at a similar angle or at a different angle or configuration. The radial features 366 may be configured to throw or move soil as the radial features 366 leave the soil. As shown in FIG. 7, when viewed from a perspective perpendicular to the axis 301 of rotation, the radial features 366 may be substantially in plane with the rest of the rim 360. In other examples, the radial features 366 may extend outwardly or inwardly from the rim 360 in the axial direction 302.

As shown in FIGS. 6D and 7-9C, the inner edge portions 374 of the modular pieces 362 may be configured to align annularly around the hub 310 and be received by the rim 360 supporting features. Each of the inner edge portions 374 of the modular pieces 362 may have a similar profile. In other examples, some of the inner edge portions 374 may have a different profile from other modular pieces 362. Generally, the inner edge portions 374 of the modular pieces 362 may have a flat cross sectional profile, as shown in FIG. 7 and FIG. 8, and when viewed from the axial direction 302, as shown in FIGS. 9B and 9C, the inner edge portions 374 may define an arcuate shape. To align the modular rim 360 with the rim support features 331 of the hub 310, the inner diameter 377 defined by the inner edge portions 374 and the circumference of the aligned inner edge portions 374 may be similar to that of the bottom wall 336 or rim support feature 331. The inner edge portion 374 may further define a radius of curvature matching a radius of curvature of the rim support features 331. The inner edge portions 374 may also have a width in the axial direction 302 similar to the width of the base wall of the recessed circumferential channel 335.

As discussed, the forward edge portions 380 of the modular pieces 362 may be a side of the modular pieces 362 configured to be oriented in the rotational direction 303 of the closing wheel relative to the rest of the modular piece 362. The forward edge portion 380 may be configured in a variety of profiles. The forward edge portions 380 may be configured to align with rear edge portions 390 of the next modular piece 362 in the rotational direction 303. The rear edge portions 390 may be a side of the modular pieces 362 on an end opposite the forward edge portions 380 and may be configured to align with the forward edge portions 380. The shapes of the forward edge portions 380 and the rear edge portions 390 may be interchangeable. In one example, the forward edge portion 380 has the same shape as the rear edge portion 390 in a second example. In another example, the forward edge portion 380 has a shape that matches a shape of the rear edge portion 390. The forward edge and the rear edge may act to radially align the modular pieces 362 of the modular rim 360.

As shown in FIG. 9A-9C, in some examples the forward edge portion 380 and the rear edge portion 390 may define modular coupling features. The modular coupling features may act to attach or retain one modular piece 362 to a next, or adjacent, modular piece 362. In one example, the forward edge portion 380 may define an extension 383. The rear edge portion 390 may define a recess 393, such as a gap. The extension 383 and recess 393 may define modular coupling features. The recess 393 may be shaped or configured to receive the extension 383. In one example, the recess 393 may define a semi-circular shape when viewed from the axial direction 302 while the extension 383 may also define a corresponding semi-circular shape that may align with the recess 393. The profiles of the shapes may be substantially U-shaped. The extension 383 of a first modular piece 362 may be placed within the recess 393 of a second modular piece 362 to link the adjacent modular pieces 362 during assembly of the modular rim 360. The recess 393 and extension 383 may be approximately parallel to the inner edge of the modular piece 362. As a result, the closing wheel may be rotated during use and the extension 383 may be retained within the recess 393 thus limiting the movement of each modular piece 362 relative to an adjacent modular piece 362. In such a configuration, the extensions 383 may be inserted into the recesses 393 of adjacent modular pieces 362 from the axial direction 302.

In additional examples, the rim coupling features may define a variety of other shapes configured to align or attach the forward edge portion 380 with the rear edge portion 390. The profiles of the forward and rear edge portions 390 may also be relatively uniform and utilize other features of the rim 360 or hub 310 to limit the movement of the modular pieces 362 during use. For example, fasteners 349 may be inserted through one or more apertures or recesses defined by the forward and rear edge portions 390. In other examples, the modular pieces 362 may receive a feature or fastener from the hub 310. In additional examples, the forward edge and the rear edge may be attached with a weld to further secure modular pieces 362 together. The weld may be a tack weld, a spot weld, or another type of weld sufficient to secure the modular pieces 362.

When assembling the modular closing wheel 300, the modular rim 360 may be assembled from the modular pieces 362 prior to coupling the modular rim 360 to the closing wheel. In other examples, the modular pieces 362 may be assembled on the rim supporting features 331, thereby coupling the modular rim 360 to the hub 310. Generally, each of the modular pieces 362 comprise a portion of the circumference of the modular rim 360 and when assembled may define the inner diameter 377. The inner diameter 377 may have a similar diameter to the rim support features 331, such as the bottom wall 336 of the recessed circumferential channel 335. When the modular rim 360 is assembled, the volume of space defined by the inner diameter 377 may define a singular aperture. In some examples, welds may secure individual modular pieces 362 to adjacent modular pieces 362, resulting in a more stable modular rim 360.

In examples where the hub 310 includes two or more portions, each of the modular pieces 362 may be configured so that the inner edge portion 374 rests on, or couples to, a rim support feature 331 of a portion of the hub 310. The modular pieces 362 may be placed and aligned such that each of the inner edge portions 374 contacts a rim support feature 331 of a portion of the hub 310, as shown in FIG. 6D. Each of the forward edge portions 380 may abut a rear edge portion 390 of another modular piece 362. When each of the forward edge portions 380 abuts a rearward edge portion of an adjacent modular piece 362 a single modular rim 360 may be defined by the modular pieces 362. As shown in FIGS. 9A and 9C, the previously described semi-circular extensions 383 and recesses 393 may function to retain each modular piece 362 to adjacent modular pieces 362. The inner diameter 377 of the modular rim 360 may be the same or similar to the diameter of the rim support features 331. The rim 360 may be press fit onto the portion of the hub 310. In one example, the modular rim 360 may have a radius of curvature similar to a radius of curvature of the rim 360 supporting features. When assembled, the height of the rim 360, which may be defined by the distance between the inner edge and the outer edge, may be greater than the height of the upright walls 337, as shown in FIG. 7. The difference in height may allow the radial features 366 of the rim 360 to extend outward from the channel a sufficient distance to engage with the soil.

In other examples, the rim support features 331 may be defined in part by the perimeter portion 315 and exist on an outer edge or face of the hub 310. In such an example, the modular rim 360 may attach to the perimeter portion 315 of the hub 310, such as at a peripheral edge, or to a face of the hub 310.

After the modular rim 360 is placed on one portion of the hub 310, such as the first portion 318, the remaining portions of the hub 310, such as the second portion 325, may be coupled to the corresponding portion of the hub 310. As shown in FIG. 6A, fasteners 349 may be inserted into the hub coupling apertures 346 to secure the portions of the hub 310 and the rim 360 between portions of the hub 310. When the portions of the hub 310 are coupled, the hub 310 may act to retain the modular rim 360 on the rim support features 331, such as within the recessed circumferential channel 335. For example, the upright walls 337 of the recessed circumferential channel 335 may act to limit movement of the modular rim 360 relative to the hub 310 by contacting the rim 360 and resisting movement of the rim 360 through friction. The rim supporting features may act to radially align the modular pieces 362 about the hub 310.

A bearing 312, or similar feature, may be inserted into the central aperture 351 of the hub 310 before or after closing coupling portions of the hub 310 together. The bearing 312 may be secured within the central aperture 351 through a feature of the hub 310. The bearing 312 may be secured by a press fit alignment with the central aperture 351. Alternatively, a feature of the trailing arm assembly 100 may secure the bearing 312. After assembling, the modular closing wheel 300 may removably couple to a feature of a trailing arm assembly for use.

During use, portions of the rim 360 may be become damaged and require replacement. A benefit of the modular rim 360 of the present disclosure may include replacing only a portion of the modular rim 360, such as a single modular piece 362, rather than the entire modular rim 360 and reduce cost and waste to an end user.

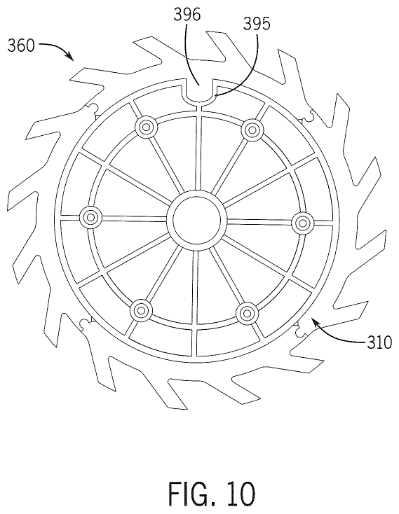

In additional examples of the modular closing wheel 300, the hub 310 and modular rim 360 may define rim retaining features to further limit movement of the modular rim 360 relative to the hub 310. In particular, it may be beneficial to limit rotation of the modular rim 360 relative to the hub 310. In one example, as shown in FIG. 10, the hub 310, or a portion of the hub 310, may define a first rim retaining feature 395. The inner edge portion 374 of a modular piece 362 may define a second rim retaining feature 396. In a first example, the first rim retaining feature 395 may be a recess and the second rim retaining feature 396 may be a protrusion. The first rim retaining feature 395 may receive the second rim-retaining feature 396. In tougher soil conditions, movement of the rim 360 may be limited relative to the hub 310 and the rim retaining features 395, 396, may resist movement. By limiting movement, more soil may be moved, or more force may be transmitted to the soil, by the modular closing wheel 300. In additional examples, the rim retaining features may define corresponding apertures configured to receive a fastener such as a screw or bolt. In other examples, the rim retaining features may alternatively define corresponding protrusions and recesses in the upright walls 337 and the modular pieces 362.

In additional examples of the modular closing wheel 300, as shown in FIGS. 6A and 8, an insert 400 may be included to limit rotation of modular rim 360 relative to the hub 310. The insert 400 may be configured for placement between the inner edge portions 374 of the modular pieces 362 and the rim supporting features. In one example, the insert 400 may be placed between the inner edge portion 374 and the bottom wall 336 of a recessed circumferential channel 335. The insert 400 may be made from any of a variety of materials exhibiting a relatively high coefficient of friction sufficient to resist movement of the rim relative to the hub 310. The materials may include rubber, polymers, or adhesives. The insert 400 may have a rectangular, round, or belt-like shape. In one example, the insert 400 may be a rubber belt. The insert 400 may extend around the entirety of the base wall. Alternatively, the insert 400 may be placed between a portion of the modular rim 360 and the hub 310. A modular rim 360 configured for use with a belt may have a comparably shorter height when compared to a modular rim 360 configured for use without an insert 400. But, when assembled, the distance of the radial features 366 from the center of the hub 310 may be the same for both closing wheels, as shown in FIGS. 7 and 8. The insert 400 may also be configured to raise a modular rim 360 to have a taller effective height and act as a spacer. This may allow the modular rim 360 to displace or break down more soil, or reach a greater depth of soil.

In one example, as shown in FIG. 6A, the insert 400 may be circular and belt shaped. The insert 400 may have a width in the axial direction 302 greater than a height in a vertical direction. The insert 400 may be placed on a portion of the hub 310 before assembly of the modular rim 360. Alternatively, the insert 400 may be placed between the modular rim 360 and a portion of the hub 310 after the rim 360 is placed on the hub 310. In another example, the insert 400 may be cut from larger source of insert material, such as a roll of material, and may be cut to a determined length sufficient to align with a desired portion between the rim 360 and the hub 310. In one example, the desired portion may be ¾ of the circumference of the inner diameter 377 of the rim 360.

Any of the features, components, and/or parts, including the arrangements and configurations thereof shown in FIG. 10 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 10.

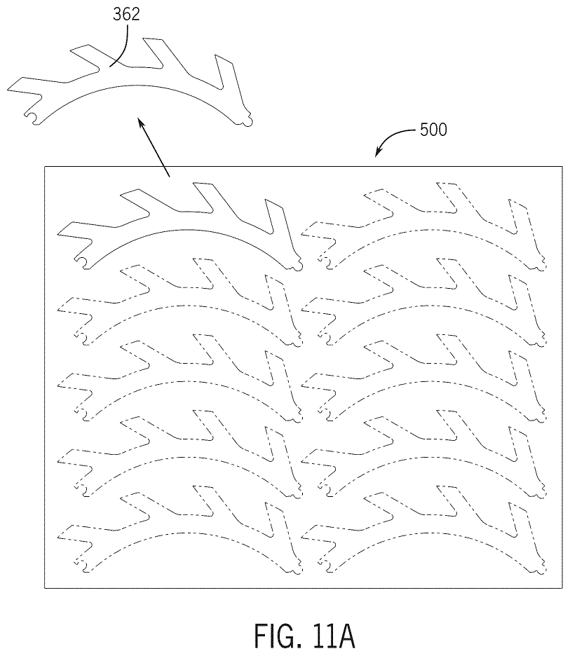

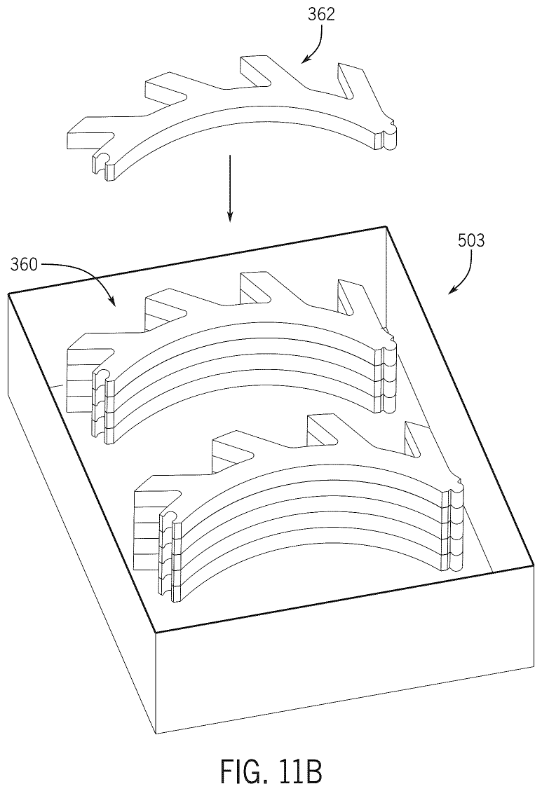

In reference to FIGS. 11A and 11B, the modular pieces 362 of the present disclosure may allow for more efficient manufacturing resulting in reduced waste and costs. A plurality of the modular pieces 362 of the present disclosure may be cut from a single sheet 500 of material. For example, the sheet of material 500 may have a thickness equal to the modular pieces 362 and have a length and width allowing multiple modular pieces 362 to be laid out in rows, columns or in a nested configuration in order to allow several modular pieces 362 to be made from one stock sheet of steel plate. The sheet 500 may be configured to reduce the amount of waste material for a given sheet 500. For example, each of the modular pieces 362 may be positioned for forming such that the inner edge portions 374 of some modular pieces 362 are located close to where the outer edge portions 365 of additional modular pieces 362 are positioned. The modular pieces 362 may be cut using a variety of methods such as laser cutting or a CNC machine. In contrast, conventional closing wheels cut from a sheet 500 of material may generate large amounts of waste from the volume of material located within the inner diameter 377 of non-modular rim that is removed from the sheets 500. Thus, a benefit of the modular rim 360 may be to reduce wasted material.

Further, because each of the modular pieces 362 may have lesser width and length than a non-modular rim, more products of the present invention may ship in a smaller-volume shipping container 503 than conventional closing wheels. For example, the modular pieces 362 may be stacked on top of each other and oriented such that multiple closing wheels may ship in a container 503. In contrast, a non-modular rim would require a box having a width and length at least equal to the outer diameter of the rim. Further, the non-modular rims would have large voids of wasted backing space defined by the inner diameter if the rims were stacked for shipment. Thus, the modular rim 360 of the present disclosure may substantially reduce shipping costs as well as reduce storage spaced utilized for the modular pieces 362.

A method of assembly a modular closing wheel 300 may also be disclosed. In one example. A first portion 318 of the hub 310 may be separated from a second portion 325 of the hub 310. An insert 400 may be optionally placed on a rim support feature 331 of the first portion 318 of the hub 310. Modular pieces 362 of the rim 360 may be placed around the rim support features 331, or structure, or around the insert 400. Each modular piece 362 may be aligned with an adjacent modular piece 362 forming a single rim 360. Alternatively, the modular pieces 362 may be assembled off the hub 310 and then placed on a portion of the hub 310 as a single rim 360. A second portion 325 of the hub 310 may be aligned with the first portion 318 of the hub 310 to secure the rim 360 or the insert 400. The first portion 318 and second portion 325 of the hub 310 may then be secured, such as with fasteners 349, to clamp the rim 360 and, or insert 400 between the first portion 318 and second portion 325 of the hub 310 forming a closing wheel 300. The closing wheel 300 may then be removably coupled to the trailing arm assembly 100 of an agricultural tractor 50.

In use, the modular closing wheel 300 may be pulled over open seed furrows 401 to break down soil and distribute soil into an open seed furrow 401 over a seed 20, effectively forming a closed seed furrow 402.

A method of manufacturing and storing a modular rim 360 may also be disclosed. The modular rim 360 may be formed from a plurality of modular pieces 362. The modular rim pieces 362 may be formed from a single sheet of material 500. The sheet of material may be a metal sheet or another material having comparable stiffness and durability for agricultural use. Before forming the modular pieces 362 from the sheet of material 500, the locations where each modular piece 362 to be taken from the sheet of material 500 may be defined. The locations of the modular pieces 362 of the CNC machine may be arranged to limit the amount of waste material, and such as by arranging to increase the proportion of material that forms the modular pieces 362 compared to the amount of material that remains in the sheet 500. Next, the modular pieces 362 may be cut, or otherwise formed, from the single sheet of material 500 by laser cutting, water jet cutting, or by similar methods. The cutting may be done with the aid of a CNC machine or some other cutting device. Each sheet of material 500 may be used to cut a variety of quantities of modular pieces 362, for example a quantity of modular pieces 362 sufficient to form one or more modular rims 360 may be formed from a single sheet of material. The newly formed modular rims pieces 362 may then be arranged for storing and shipping.

In at least one example, a method of manufacturing a modular rim of an agricultural wheel may include providing the sheet 500 of material defining a cutting area and cutting a set of modular pieces 362 from the sheet 500 of material within the cutting area, the set of modular pieces 362 configured to be assembled together to form the modular rim. In such an example, the cutting area is less than an area defined by an outer diameter of the modular rim when assembled.

By way of a non-limiting example, if the sheet 500 was a 4-ft by 6-ft piece of ¼-inch thick of material, and the modular rim 360 had an outer diameter of about 13-inches, cutting the rim 360 as a single piece from the sheet 500 would allow a manufacturer to cut fifteen rims 360 from each sheet 500. However, if the modular rim 360 were cut as modular pieces 362 as shown in FIG. 9B from the same 4-ft by 6-ft sheet 500 and subsequently assembled, about one-hundred and seventy-five modular pieces 362 or more could be cut, which could be assembled into approximately forty-three rims 360 of the same 13-inch outer diameter size with three modular pieces 362 left over. These numbers and dimensions are exemplary only and not meant to be limiting. Other dimensions of the sheet 500, modular rim 306, and modular pieces 362 can be used. In any example, however, more rims 360 can be cut from a single piece/sheet of material when individual modular pieces 362 are cut and then the modular rim 360 is assembled form the modular pieces 362.

Once the modular pieces 362 are cut, each of the modular rim pieces 362 may be arranged in a selected box or shipping container 503. Generally, the modular pieces 362 may be arranged to reduce a total volume of space taken up by the modular pieces 362. The arrangement of the modular pieces 362 may be selected based off a known shipping container 503 volume. For example, the container 503 may be a standard size and the modular pieces 362 may be arranged to increase the amount of modular pieces 362 that may be placed in the container 503 or to reduce the amount of space the arranged modular pieces 362 take up within the container. In other examples, the container 503 may be selected to have a volume sufficient to hold the modular pieces 362. The modular pieces 362 may be arranged so that an arrangement of the modular pieces 362 may include the exact amount needed to form a complete modular rim 360. In other examples, the modular pieces 362 may be arranged to match an order quantity or to minimize a total number of containers 503 needed to store or ship an amount of modular pieces 362.

Any of the features, components, and/or parts, including the arrangements and configurations thereof shown in FIGS. 11A and 11B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 11A and 11B.

Other examples and implementations are within the scope and spirit of the disclosure and appended claims. For example, features implementing functions may also be physically located at various positions, including being distributed such that portions of functions are implemented at different physical locations. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A closing wheel coupled to a trailing arm assembly of a planter, the closing wheel comprising:
a hub including a base wall defining a recessed circumferential channel, the base wall having a radius of curvature; and
a rim configured to couple to the hub within the circumferential channel and around the base wall, the rim comprising a plurality of modular pieces, each of the plurality of modular pieces including:
an inner edge defining a curved surface having the radius of curvature;
an outer edge opposite the inner edge, the outer edge defining repeating radial extensions;
a forward edge extending between the inner edge and the outer edge; and
a rearward edge, the rearward edge opposite the inner edge and configured to abut a forward edge of an adjacent modular piece.

2. The closing wheel of claim 1, the hub comprising:
a first portion; and
a second portion configured to couple to the first portion, wherein when coupled, the first portion and second portion define the recessed circumferential channel and the base wall.

3. The closing wheel of claim 1, further comprising an insert, the insert configured to align annularly between the inner edge of the rim and the base wall of the hub when the rim is coupled to the base wall, wherein the insert is configured to limit a movement of the rim relative to the hub.

4. The closing wheel of claim 3, wherein the insert comprises a rubber belt.

5. The closing wheel of claim 1, further comprising:
a first retaining feature defined by the hub; and
a second retaining feature defined by the rim and configured to engage the first retaining feature to limit a movement of the rim relative to the hub.

6. The closing wheel of claim 1, wherein:
the forward edge defines a first modular coupling feature; and
the rearward edge defines a second modular coupling feature configured to engage the first modular coupling feature of an adjacent piece of the plurality of modular pieces to couple the adjacent pieces together.

7. The closing wheel of claim 6, wherein:
the first modular coupling feature defines an extension from the forward edge and the second modular coupling feature defines a recess in the rearward edge.

8. The closing wheel of claim 1, wherein the repeating radial extensions are configured to disturb soil to close a seed furrow.

9. A closing wheel, comprising:
a hub comprising:
a first portion;
a second portion coupleable to the first portion to define a base wall and two opposing sidewalls, the base wall and sidewalls defining a recessed circumferential channel with a radius of curvature;
an aperture extending through a center of the first and second portions and configured to receive an extension of an agricultural trailing arm assembly; and
a modular rim including:
a plurality radially aligned modular pieces, the modular rim defining repeating radial extensions extending from an outer edge of the modular rim; and
an inner edge opposite the outer edge, the inner edge having the radius of curvature;
wherein the opposing sidewalls of the hub limit a movement of the modular rim relative to the hub.

10. The closing wheel of claim 9, further comprising an insert configured to align annularly between the inner edge of the rim and the base wall of the hub when the rim is coupled to the base wall, wherein the insert is configured to limit the movement of the rim relative to the hub.

11. The closing wheel of claim 9, further comprising:
a first retaining feature defined by the base wall; and
a second retaining feature defined by at least one modular piece and configured to align with the first retaining feature;
wherein the first and second retaining features limit the movement of the rim relative to the hub.

12. The closing wheel of claim 9, wherein the each modular piece of the plurality of modular pieces comprises:
a forward edge defining a first modular coupling feature; and
a rearward edge opposite the forward edge and defining a second modular coupling feature configured to align with the first modular coupling feature of an adjacent modular piece of the plurality of modular pieces.

13. The closing wheel of claim 12, wherein the first modular coupling feature and the second modular coupling feature define welds.

14. The closing wheel of claim 12, wherein the first modular coupling feature defines an extension from the forward edge of a first modular piece and the second modular coupling feature defines a recess in the rearward edge of a second modular piece, wherein the extension is received by the recess to couple the first and second modular pieces.

15. The closing wheel of claim 9, wherein the radial extensions are configured to disturb soil to close a seed furrow when the wheel is coupled to the agricultural trailing arm assembly.

16. A closing wheel configured to couple to a trailing arm of an agricultural tractor, the seed furrow closing wheel comprising:
a modular rim comprising a plurality of modular pieces and having an inner circumferential edge defining a radius of curvature and an aperture, each modular piece of the plurality of modular pieces comprising:
an outer edge defining repeating radial extensions extending outwardly and configured to disturb soil;
a first side defining a first modular coupling feature;
a second side opposite the first side, the second side defining a second modular coupling feature; and
wherein the second modular coupling feature is configured to couple with the first modular coupling feature of an adjacent modular piece of the plurality of modular pieces; and
a rim support structure coupled to an extension of the trailing arm and defining a base wall having the radius of curvature and configured to support the modular rim.

17. The closing wheel of claim 16, the rim support structure comprising:
a first portion defining a first section of the base wall; and
a second portion defining a second section of the base wall, the second portion configured to couple to the first portion.

18. The closing wheel of claim 16, further comprising:
an insert configured to align annularly between the inner circumferential edge and the base wall, wherein the insert limits a movement of the modular rim relative to the rim support structure.

19. The closing wheel of claim 16, further comprising:
a first retaining feature defined by the rim support structure; and
a second retaining feature defined by the modular rim and configured to align with the first retaining feature;
wherein the first and second retaining features are coupled to limit a movement of the modular rim relative to the rim support structure.

20. The closing wheel of claim 16, wherein:
the first modular coupling feature defines an extension;
the second modular coupling feature defines a gap; and
adjacent modular pieces of the plurality of modular pieces couple when the extension of a first modular piece of the adjacent modular pieces is placed in the gap of a second modular piece of the adjacent modular pieces.

21. A wheel coupled to a planter assembly towed by an agricultural tractor, the wheel comprising:
a hub having a peripheral edge portion;
a rim comprising a plurality of modular pieces, each of the plurality of modular pieces including:
an inner edge;
an outer edge opposite the inner edge, the outer edge defining at least one radial extension;
a forward edge extending between the inner edge and the outer edge; and
a rearward edge, the rearward edge opposite the inner edge and configured to abut a forward edge of an adjacent modular piece; and
wherein the plurality of modular pieces are positioned around and attached to the peripheral edge portion.

22. The wheel of claim 21, wherein the plurality of modular pieces are attached to the peripheral edge portion and are fixed relative to the hub.

23. The wheel of claim 21, wherein the plurality of modular pieces are each engaged with two adjacent modular pieces.

24. A method of manufacturing a modular rim of an agricultural wheel, the method comprising:
providing a sheet of material defining a cutting area; and
cutting a set of modular pieces from the sheet of material within the cutting area, the set of modular pieces configured to be assembled together to form the modular rim,
wherein:
the cutting area is less than an area defined by an outer diameter of the modular rim when assembled; and
each modular piece of the set of modular pieces comprises:
an inner edge defining a curved surface;
an outer edge opposite the inner edge, the outer edge defining repeating radial extensions;
a forward edge extending between the inner edge and the outer edge; and
a rearward edge, the rearward edge opposite the inner edge and configured to engage a forward edge of an adjacent modular piece.
